(19) United States
(12) Patent Application Publication
(10) Pub. No.: US 2012/0009544 A1
(43) Pub. Date: Jan. 12, 2012

(54) GUIDE PIN FOR DENTAL IMPLANTATION

(76) Inventor: Hsieh-Hsing LIN, NEW TAIPEI CITY (TW)

(21) Appl. No.: 13/174,098

(22) Filed: Jun. 30, 2011

(30) Foreign Application Priority Data
Jul. 7, 2010 (TW) 099212904

(51) Int. Cl. A61C 13/225

(52) U.S. Cl. 433/172

(57) ABSTRACT

The guide pin in accordance with the present invention has an elongated body made from a ceramic material capable of bone density indication and comprising multiple coaxial cylindrical sections of different heights and diameters.

### BACKGROUND OF THE INVENTION

1. Field of the Invention

The present invention relates to a guide pin for presurgical evaluation of dental implantation, especially to a guide pin that is orientational and comprises an elongated body comprising cylindrical sections, each for indicating a bone density condition.

2. Description of the Prior Art

Teeth are indispensable for chewing food and are also crucial for aesthetic appearance. For treating edentulism, dental implantation is a widely accepted option. A process of dental implantation includes embedding an implant in an edentulous site on the alveolar bone of the patient, waiting for the implant to become osseointegrated, and mount a prosthetic tooth to the implant.

A surgery for dental implantation requires careful presurgical evaluation regarding multiple aspects. For example, alveolar space, bone density of the alveolar bone, the condition of the gum, and positioning of the roots of neighboring teeth, are parameters to be evaluated for determining a suitable dental implant and the depth and angle for implementing the dental implant.

With reference to FIG. 8, X-ray orthopantomographs are taken for visual presurgical evaluation to determine the depth and angle for osteotomic drilling. The presurgical evaluation includes constructing a dental plaster model for the patient, designing a guide plate with the plaster model for osteotomy orientation towards the edentulous site that the guide plate comprises one or multiple guide holes according to the number of teeth the patient has lost, placing a metal ball 40 in one guide hole, installing the guide plate with the metal ball 40, taking an orthopantomograph of the patient to visually determine the edentulous site, calculating the relative position and distance of the metal ball 40 and the alveolar bone 43 on the orthopantomograph, and calculating the depth and diameter of a osteotomic hole to be drilled in the gum 50 and the alveolar bone 43 during the dental implantation surgery.

However, the orthopantomograph does not visualize the guide plate, which is usually made from wax or resin, but the ball 40 that, however, provides no information on orientation and fails to particularly point out the direction along which the implant is to be implanted. The surgeon may only empirically determine the actual angle and depth of the osteotomic hole according to the comparison of the roots of the neighboring teeth 42 and the depth of the gum 50. Malpractice due to faults in empirical judgments produces an osteotomic hole of inaccurate angle and depth that in turn leads to illness and defects in appearance. Bone densities of the alveolar bones 43 of patients vary and are a factor for determining the diameter of an osteotomic hole that is able to effectively hold the implant within. The foregoing conventional means for presurgical evaluation with orthopantomographs through visualize the bone density of the patient, it requires a surgeon to empirically judge if the bone density is under osteoporosis or is normal. A surgeon with insufficient experiences may misjudge on that issue and raise the probability of failure of the dental implantation.

To overcome the shortcomings, the present invention provides a guide pin for dental implantation to mitigate or obviate the aforementioned problems.

### SUMMARY OF THE INVENTION

The main objective of the invention is to provide a guide pin for dental implantation for overcoming problems of the conventional means for presurgical evaluation including misjudgment of the depth and angle of the osteotomic hole and failure to provide more information for drilling an osteotomic hole. The guide pin helps to provide information of accurate depth and angle of a suitable osteotomic hole and of bone density of the alveolar bone of the patient.

The guide pin in accordance with the present invention has an elongated body made from a ceramic material capable of bone density indication and comprising multiple coaxial cylindrical sections of different heights and diameters, whose densities are approximately the density of human bones. The multiple cylindrical sections may be an upper cylindrical section for indicating a bone density condition of osteoporosis, a middle cylindrical section for indicating a normal bone density condition, and a lower cylindrical section for indicating a bone density condition of osteopetrosis, in combination with which orthopantomographs may provide information with reference to the angle and position of the guide pin and information of bone density of the patient.

The guide pin for dental implantation is used in a process for dental implantation comprising designing a guide plate with a plaster model for osteotomy orientation towards the edentulous site that the guide plate comprises one or multiple guide holes according to the number of teeth the patient has lost, placing the guide pin in one guide hole, installing the guide plate with the guide pin, taking an orthopantomograph of the patient to visually determine the edentulous site. The orthopantomograph taken with the guide pin shows the position and angle of the guide pin at the edentulous site, neighboring teeth and the alveolar bone. With reference to the angle of the guide pin and the distance between a bottom of the guide pin and the alveolar bone along the orientation of the guide pin, the depth of a suitable osteotomic hole with consideration on the thickness of the gum may be obtained. With further reference to the comparison of the image of the alveolar bone and to the bone density image of the guide pin, the surgeon may observe the bone density of the alveolar bone and determine if it is necessary to adjust the diameter of the osteotomic hole.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a guide pin in accordance with the present invention;

FIG. 2 is a cross sectional side view of the guide pin in FIG. 1;

FIG. 3 is a first operational perspective view of a plaster model on which a guide plate is to be formed;

FIG. 4 is a second operational perspective view of the plaster model in FIG. 3;

FIG. 5 is a third operational perspective view of the plaster model in FIG. 3 and a guide plate formed thereon;

FIG. 6 is an operational perspective view of the guide plate in FIG. 5 applied to an edentulous site of the alveolar bone;

FIG. 7 is a schematic graph of an orthopantomograph taken with the guide pin in FIG. 1; and

FIG. 8 is a schematic graph of an orthopantomograph taken with a conventional guide plate and a conventional metal ball in accordance with the prior art.

### DETAILED DESCRIPTION OF THE PREFERRED EMBODIMENTS

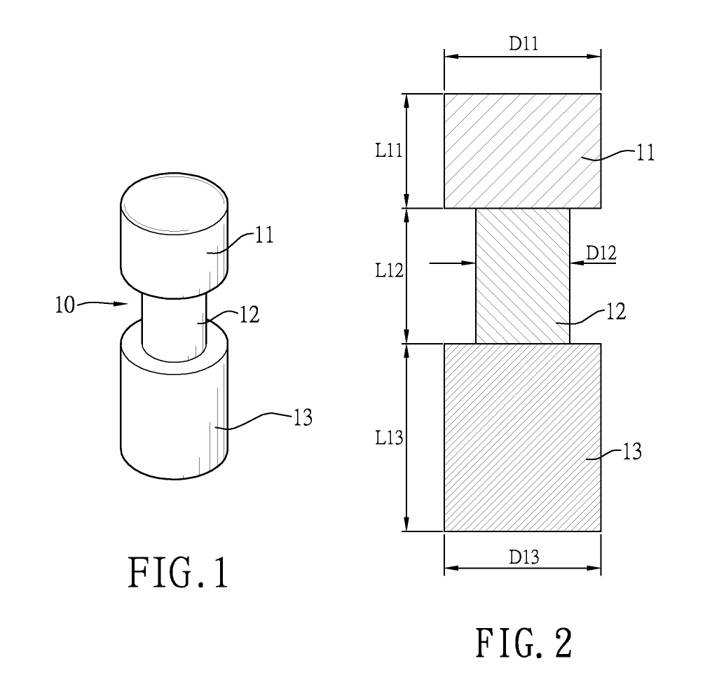

With reference to FIG. 1, a guide pin 10 in accordance with the present invention comprises an elongated body made from a ceramic material capable of bone density indication and comprising multiple coaxial cylindrical sections of different heights and diameters. The elongated body is multi-sectionally columnar, and each of the multiple cylindrical sections of different heights and diameters are for indicating a bone density condition. Specifically, the elongated body comprises three coaxial cylindrical sections of different heights and diameters. The three coaxial cylindrical sections are an upper cylindrical 11 section for indicating a bone density condition of osteoporosis, a middle cylindrical section 12 for indicating a normal bone density condition, and a lower cylindrical section 13 for indicating a bone density condition of osteopetrosis.

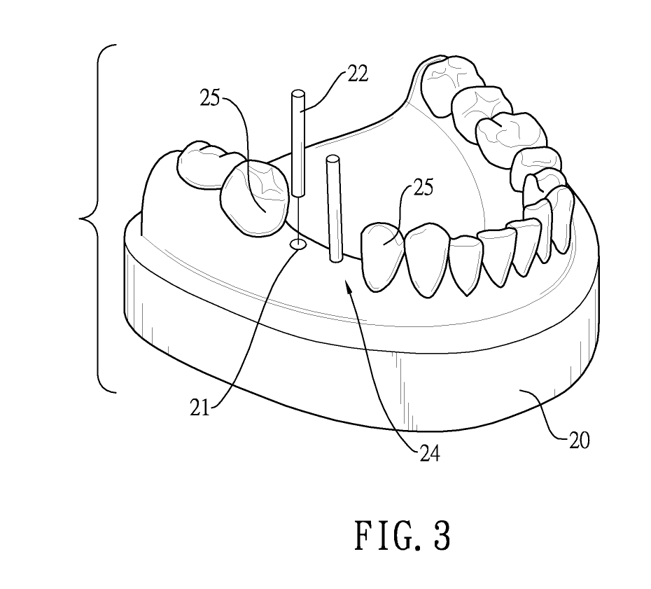

With further reference to FIG. 2, the upper cylindrical section 11 for indicating a bone density condition of osteoporosis, or soft bone condition, comprises a diameter D11 and a height L11. The middle cylindrical section 12 for indicating a normal bone density condition, or normal bone condition, comprises a diameter D12 and a height L12. The lower cylindrical section 13 for indicating a bone density condition of osteopetrosis, or dense bone condition, comprises a diameter D13 and a height L13. The aforementioned L13 is larger than L12 and L12 than L11, while D13 and D11 are larger than D12. Preferably, D13 is equal to D11. The multiple cylindrical sections 11, 12 and 13 are of different density. A density of the lower cylindrical section 13 is larger than a density of the middle cylindrical section 12 and the density of the middle cylindrical section 12 is larger than a density of the upper cylindrical section 11.

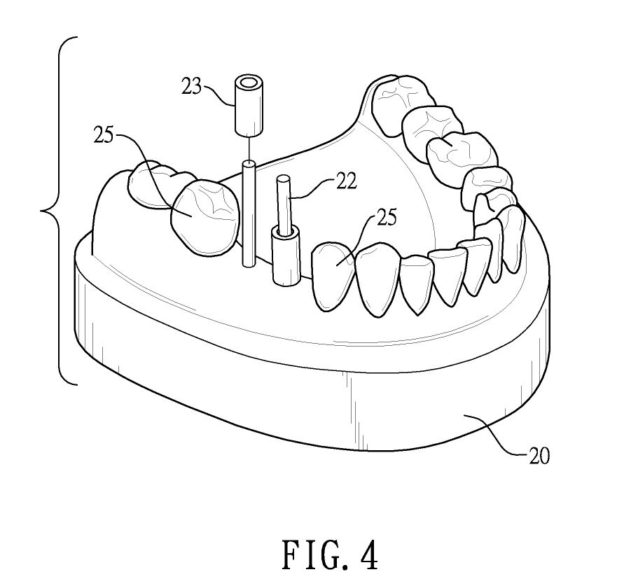

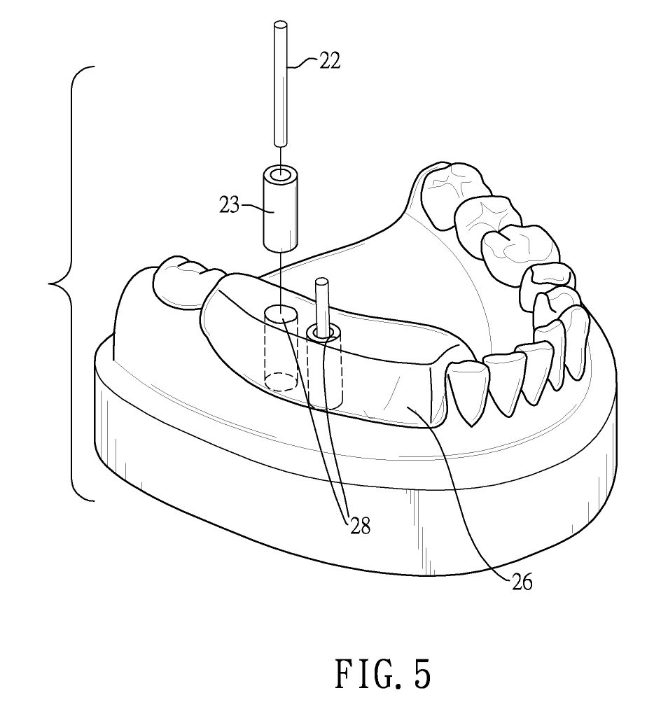

With the aforementioned structure, the guide pin 10 is able to demonstrate reference image for judging bone density. One feasible example of the guide pin 10 comprises kaolin, silicon carbide (SiC), aluminum oxide (Al₂O₃) and PVA of different ratio, so as to make ceramics of different densities. In the instant example of the guide pin 10, the upper cylindrical section 11 for indicating soft bone condition is rendered to have a density of 1250 Hounsfield units (“HU”), the middle cylindrical section 12 for indicating normal bone condition is rendered to have a density of 850 HU, and the lower cylindrical section 13 for indicating dense bone condition is rendered to have a density of 350 HU. With reference to FIGS. 3 to 5, a dental implantation process, which includes drilling a osteotomic hole, performed with the guide pin 10 comprises constructing a dental plaster model 20 for the patient, calculating a suitable drilling position with the plaster model 20, drilling an osteotomic hole 21 at a edentulous site 24, mounting a basal rod 22 in the osteotomic hole 21 and mounting a leading rod 23 around the basal rod 22, covering a covering material that may be wax or resin over the basal rod 22 and the leading rod 23 with neighboring teeth 25, allowing the covering material to solidify, forming a guide hole 28 on the covering material by detaching the basal rod 22 and the leading rod 23, and obtaining a guide plate 26 (see FIG. 5) with the guide hole 28 formed thereon. The guide hole 28 serves as an indicator to the position for drilling. More than one guide holes 28 may be formed according the number of teeth the patient has lost.

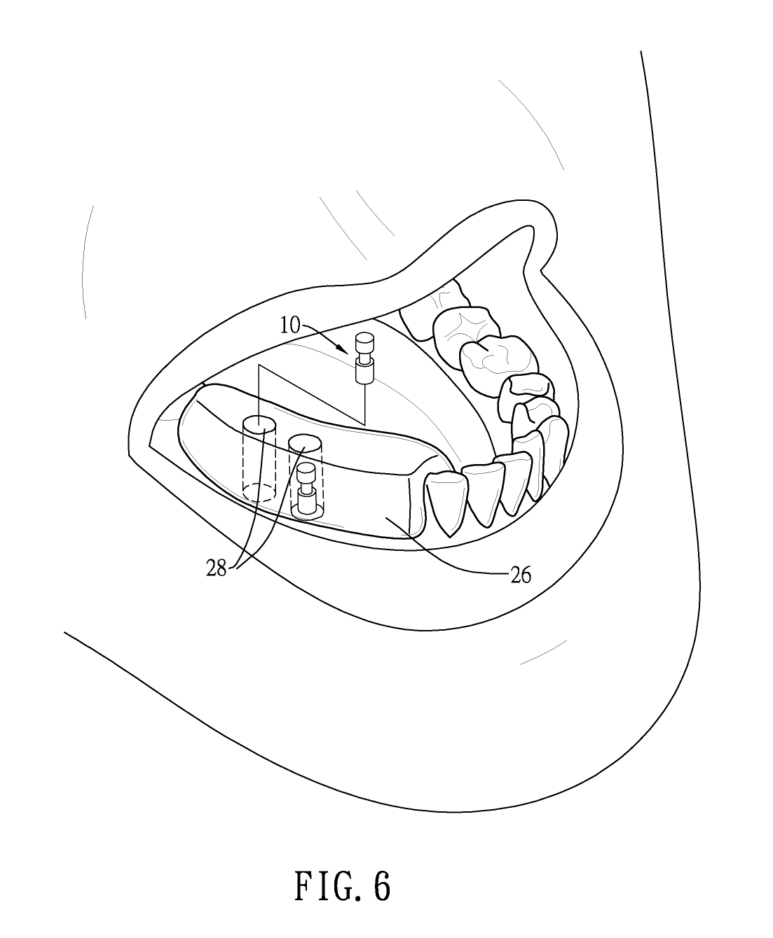

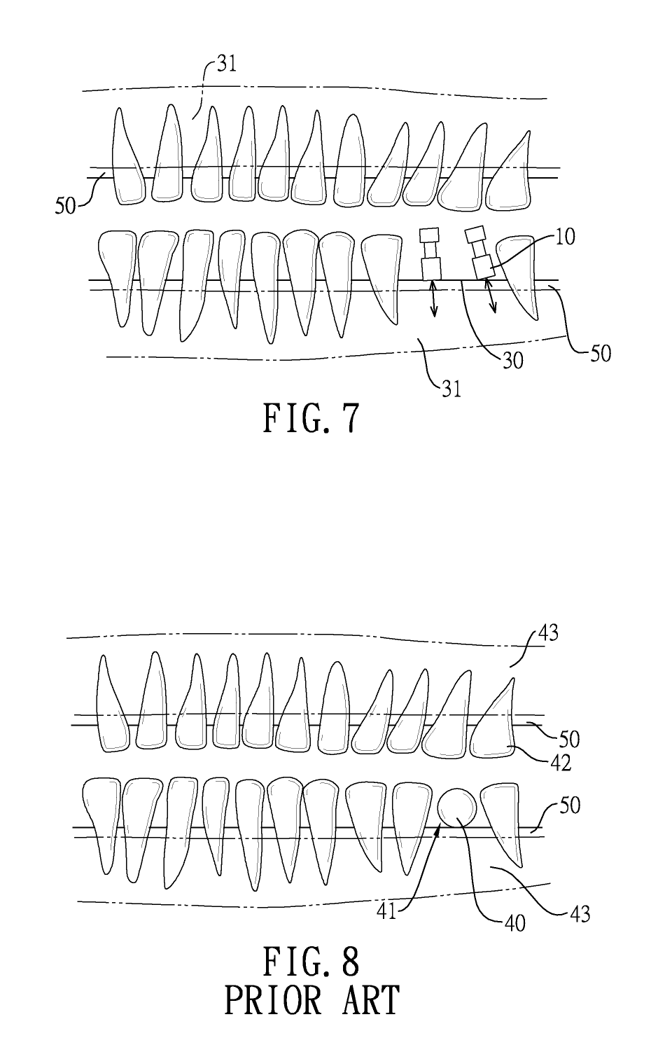

With reference to FIGS. 6 and 7, the dental implantation process further comprises placing the guide plate 26 at the edentulous site 30, placing the guide pin 10 in the guide hole 28 of the guide plate 26, and taking an orthopantomograph of the patient with the guide plate 26. The orthopantomograph visualizes the position and angle of the guide pin 10 at the edentulous site 30, neighboring teeth 25 and the alveolar bone 31. With reference to the length and the angle of the guide pin 10 and the distance between a bottom of the guide pin 10 through the gum 50 and the alveolar bone 31 along the orientation of the guide pin 10, the depth of a suitable osteotomic hole with consideration on the thickness of the gum 50 may be obtained. With further reference to the comparison of the image of the alveolar bone 31 and to the bone density image of the guide pin 10, preferably, to the respective cylindrical sections 11, 12 and 13 thereof, the surgeon may observe the bone density of the alveolar bone 31 of the patient. Bones may be categorized according to their density as demonstrated in the following Table 1.

TABLE 1

| Bone density | | Description |
|---|---|---|
| Larger than 1250 | HU | Dense cortical bone |
| 850-1250 | HU | Thick dense to porous cortical bone |
| 350-850 | HU | Thin porous cortical bone |
| 150-350 | HU | Spongy bone |
| Less than 150 | HU | Immature, non-mineralized bone |

With the understanding on the patient's bone density condition, the surgeon may decide if it is necessary to adjust the diameter of the osteotomic hole prior to the surgery, which greatly raises successful rate of the surgery.

What is claimed is:

1. A guide pin for dental implantation comprising
an elongated body made from a ceramic material capable of bone density indication and comprising
multiple coaxial cylindrical sections of different heights and diameters.

2. The guide pin as claimed in claim 1, wherein the elongated body is multi-sectionally columnar.

3. The guide pin as claimed in claim 1, wherein each of the multiple cylindrical sections of different heights and diameters are for indicating a bone density condition.

4. The guide pin as claimed in claim 1, wherein each of the multiple cylindrical sections of different heights and diameters indicates a bone density condition.

5. The guide pin as claimed in claim 3, wherein the bone density condition is selected from the group consists of osteoporosis, normal and osteopetrosis.

6. The guide pin as claimed in claim 3, wherein the elongated body comprises
three coaxial cylindrical sections of different heights and diameters, wherein the three coaxial cylindrical sections are
an upper cylindrical section for indicating a bone density condition of osteoporosis,
a middle cylindrical section for indicating a normal bone density condition, and
a lower cylindrical section for indicating a bone density condition of osteopetrosis.

7. The guide pin as claimed in claim 4, wherein the bone density condition is selected from the group consists of osteoporosis, normal and osteopetrosis.

8. The guide pin as claimed in claim 4, wherein the elongated body comprises
three coaxial cylindrical sections of different heights and diameters, wherein the three coaxial cylindrical sections are
an upper cylindrical section for indicating a bone density condition of osteoporosis,
a middle cylindrical section for indicating a normal bone density condition, and
a lower cylindrical section for indicating a bone density condition of osteopetrosis.

9. The guide pin as claimed in claim 6, wherein a height of the lower cylindrical section is larger than a height of the middle cylindrical section,
the height of the middle cylindrical section is larger than a height of the upper cylindrical section, a diameter of the lower cylindrical section is larger than a diameter of the middle cylindrical section, and
a diameter of the upper cylindrical section is larger than the diameter of the middle cylindrical section.

10. The guide pin as claimed in claim 8, wherein a height of the lower cylindrical section is larger than a height of the middle cylindrical section,
the height of the middle cylindrical section is larger than a height of the upper cylindrical section, a diameter of the lower cylindrical section is larger than a diameter of the middle cylindrical section, and
a diameter of the upper cylindrical section is larger than the diameter of the middle cylindrical section.
